(19) United States
(12) Patent Application Publication
(10) Pub. No.: US 2026/0280058 A1
(43) Pub. Date: Sep. 17, 2026

(54) CONDUCTIVE MODULE

(71) Applicants: YAZAKI CORPORATION, Tokyo (JP); Prime Planet Energy & Solutions, Inc., Tokyo (JP)

(72) Inventors: Yasuhiro Kominato, Makinohara-shi (JP); Katsunori Sato, Makinohara-shi (JP); Go Yamashiro, Miyoshi-shi (JP)

(21) Appl. No.: 19/567,397

(22) Filed: Mar. 16, 2026

(30) Foreign Application Priority Data
Mar. 17, 2025 (JP) 2025-042019

(51) Int. Cl. H01M 50/505; H01M 50/271; H01M 50/517; H02G 5/06

(52) U.S. Cl. CPC H01M 50/505; H01M 50/271; H01M 50/517; H02G 5/066

(57) ABSTRACT

A conductive module includes a bus bar, a housing member provided with a bus bar housing chamber that houses the bus bar inserted from a bus bar insertion port at a housing completion position, and a cover member provided with a bus bar cover portion that closes the bus bar insertion port and covers the bus bar, in which the bus bar housing chamber is provided with a bus bar placement portion on which the bus bar at the housing completion position is placed at a location avoiding a connection position between the bus bar and an electrode terminal of a battery cell and on the battery cell side relative to the bus bar insertion port.

### CROSS-REFERENCE TO RELATED APPLICATION(S)

The present application claims priority to and incorporates by reference the entire contents of Japanese Patent Application No. 2025-042019 filed in Japan on Mar. 17, 2025.

### BACKGROUND OF THE INVENTION

### 1. Field of the Invention

The present invention relates to a conductive module.

### 2. Description of the Related Art

In the related art, a battery pack for supplying power to a rotary machine serving as a drive source is mounted in a vehicle such as an electric vehicle. The battery pack includes a battery module obtained by arranging a plurality of battery cells therein, and a conductive module that electrically connects the respective battery cells to a bus bar and transmits information on battery states of the battery cells to a battery monitoring unit. The conductive module is provided with a housing member that houses and holds the bus bar in a bus bar housing chamber. For example, in the bus bar housing chamber, the bus bar is held by using a locking claw that hooks the bus bar from the side opposite to the battery cell side. This type of conductive module is disclosed in, for example, Japanese Patent Application Laid-open No. 2014-220069.

In a conductive module of the related art, a bus bar is inserted under a locking claw while being pushed into a bus bar housing chamber. Further, a pressing portion having a hinge structure is closed, and the bus bar is covered and sandwiched by the pressing portion from a side opposite to a battery cell side. Therefore, in the conductive module of the related art, when viewed from the bus bar, the size of a housing member becomes large on the side opposite to the battery cell side, and there is a possibility that height reduction is hindered.

### SUMMARY OF THE INVENTION

Therefore, an object of the present invention is to provide a conductive module provided with a bus bar holding structure capable of reducing height.

A conductive module according to one aspect of the present invention includes a bus bar physically and electrically connected to an electrode terminal of one or a pair of battery cells in a battery module having a plurality of the battery cells arranged therein in a row; a housing member provided with a bus bar housing chamber configured to house the bus bar inserted from a bus bar insertion port at a housing completion position; and a cover member provided with a bus bar cover portion configured to close the bus bar insertion port and to cover the bus bar, wherein the bus bar housing chamber is provided with a bus bar placement portion and a plurality of positioning pins, the bus bar placement portion being configured for the bus bar at the housing completion position to be placed at a location avoiding a connection position between the bus bar and the electrode terminal and on the battery cell side relative to the bus bar insertion port, the positioning pins protruding from the battery cell side toward the bus bar insertion port at the location avoiding the connection position, the bus bar has a positioning hole formed therein and provided for each of the positioning pins, the positioning hole being configured for the positioning pin to be inserted thereinto at the housing completion position, and the cover member is provided with a bus bar pressing portion placed on the bus bar at the housing completion position, the bus bar pressing portion and the bus bar placement portion sandwiching the bus bar therebetween.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is a perspective view illustrating the conductive module according to the embodiment, and illustrates a state in which a bus bar cover portion is opened;

FIG. 3 is an exploded perspective view illustrating the conductive module according to the embodiment;

FIG. 4 is an exploded perspective view extracting a main part of the conductive module according to the embodiment;

FIG. 5 is a perspective view illustrating the main part of the conductive module according to the embodiment; and

FIG. 6 is an explanatory diagram for description of a battery module.

### DETAILED DESCRIPTION OF THE PREFERRED EMBODIMENTS

Hereinafter, an embodiment of a conductive module according to the present invention will be described in detail with reference to the drawings. Note that the present invention is not limited by the embodiment.

### Embodiment

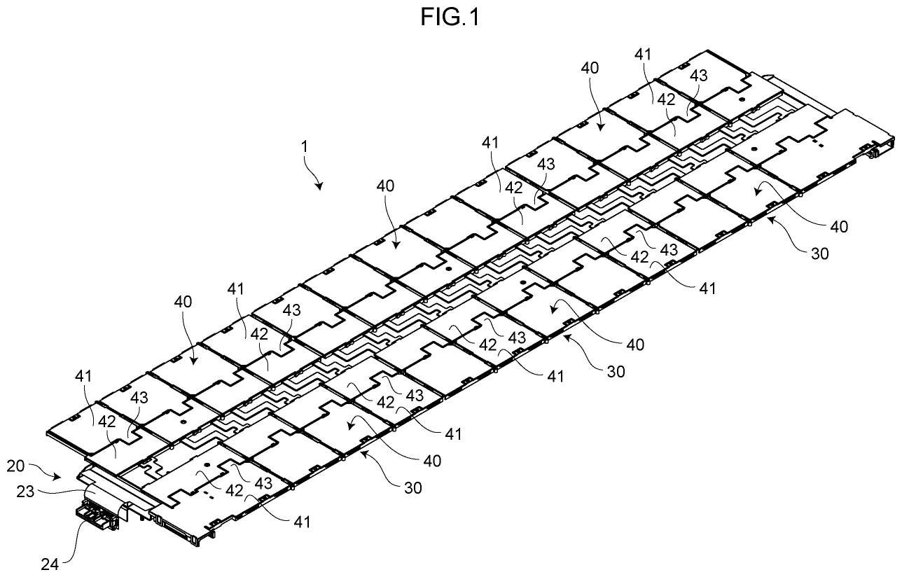

One of the embodiments of a conductive module according to the present invention will be described with reference to FIGS. 1 to 6.

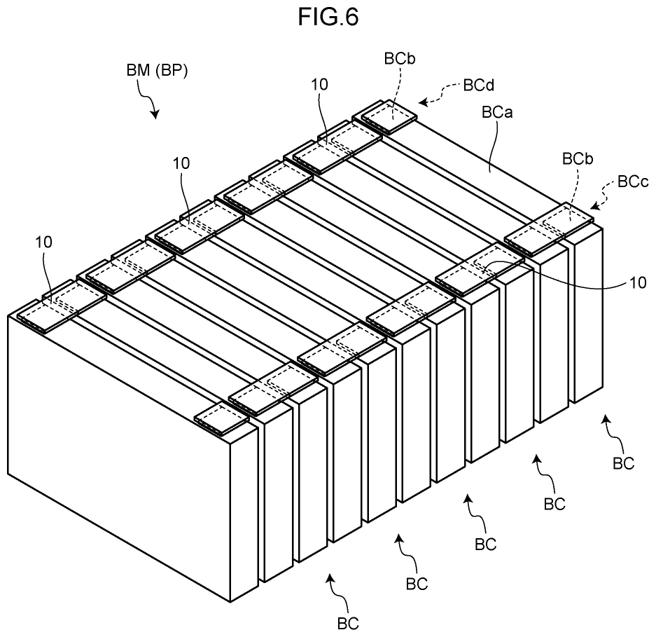

Reference numeral 1 in FIGS. 1 to 5 denotes a conductive module according to the present embodiment. The conductive module 1 is assembled with a battery module BM (FIG. 6) in which a plurality of battery cells BC are arranged in a row. The conductive module 1 electrically connects the plurality of battery cells BC in the battery module BM. In addition, the conductive module 1 electrically connects the battery module BM to a battery monitoring unit (not illustrated) that monitors a battery state of the battery cell BC, thereby causing the battery monitoring unit to monitor the battery state (voltage, temperature, and the like) of the battery cell BC. The conductive module 1 forms a battery pack BP together with the battery module BM (FIG. 6). The battery pack BP is mounted on, for example, a vehicle (battery electric vehicle (BEV), hybrid electric vehicle (HEV), and the like) including a rotary machine as a drive source, and is used to supply power to the rotary machine. The configuration of the battery module BM in the drawing, such as the number of battery cells BC, is simplified for convenience of description.

The battery cell BC includes a cell body BCa and positive and negative electrode terminals BCb (FIG. 6). In the battery cell BC illustrated here, the cell body BCa is formed in a rectangular parallelepiped shape having six outer wall surfaces. In the plurality of battery cells BC forming the battery module BM, the cell bodies BCa adjacent to each other in an arrangement direction are arranged with their single outer wall surfaces facing each other. The battery module BM includes one electrode terminal group BCc in which one electrode terminal BCb of each battery cell BC is arranged in the arrangement direction, and the other electrode terminal group BCd in which the other electrode terminal BCb of each battery cell BC is arranged in the arrangement direction (FIG. 6).

Hereinafter, in a case in which term “arrangement direction” is described while not particularly mentioned, the term refers to the arrangement direction of the plurality of battery cells BC and the arrangement direction of the plurality of electrode terminals BCb in the electrode terminal groups BCc and BCd.

In this example, each battery cell BC includes positive and negative electrode terminals BCb on one of the six outer wall surfaces of the cell body BCa (FIG. 6). Therefore, in the battery module BM, two electrode terminal groups BCc and BCd are provided on one plane (FIG. 6).

In addition, the electrode terminal BCb illustrated here is formed in a flat plate shape and is physically and electrically connected to a plate-shaped bus bar 10 to be described later by welding or the like (FIG. 6).

The conductive module 1 includes the bus bar 10 and a wiring component 20 (FIGS. 1 to 5). The conductive module 1 includes a housing member 30 that houses the bus bar 10 and the wiring component 20, and a cover member 40 assembled with the housing member 30 (FIGS. 1 to 5).

The bus bar 10 is a plate-shaped conductive member for terminal connection that is physically and electrically connected to the electrode terminal BCb of one or a pair of battery cells BC in the battery module BM. The bus bar 10 is formed of a conductive material such as metal. For example, the bus bar 10 is press-molded using a metal plate as a base material.

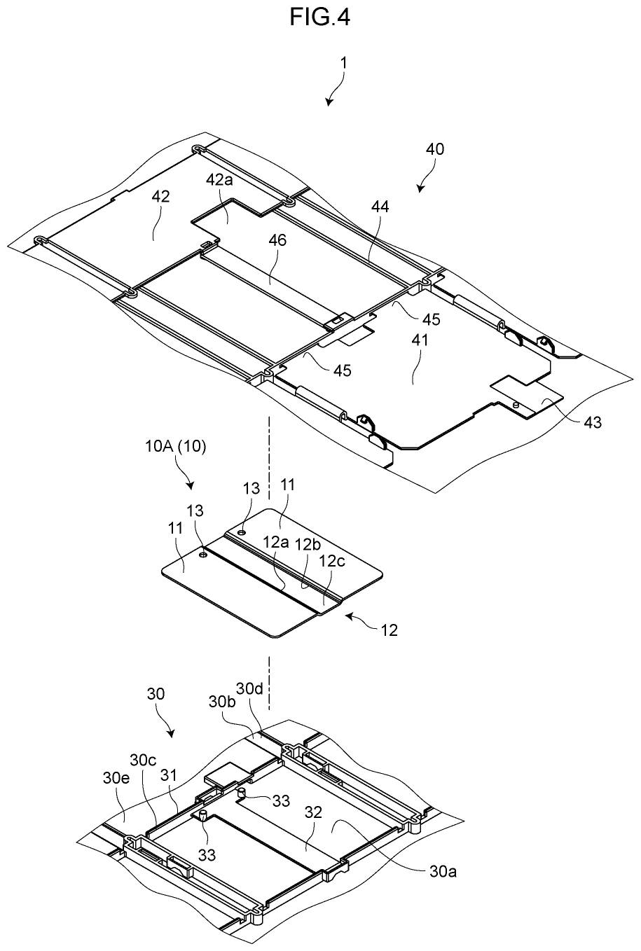

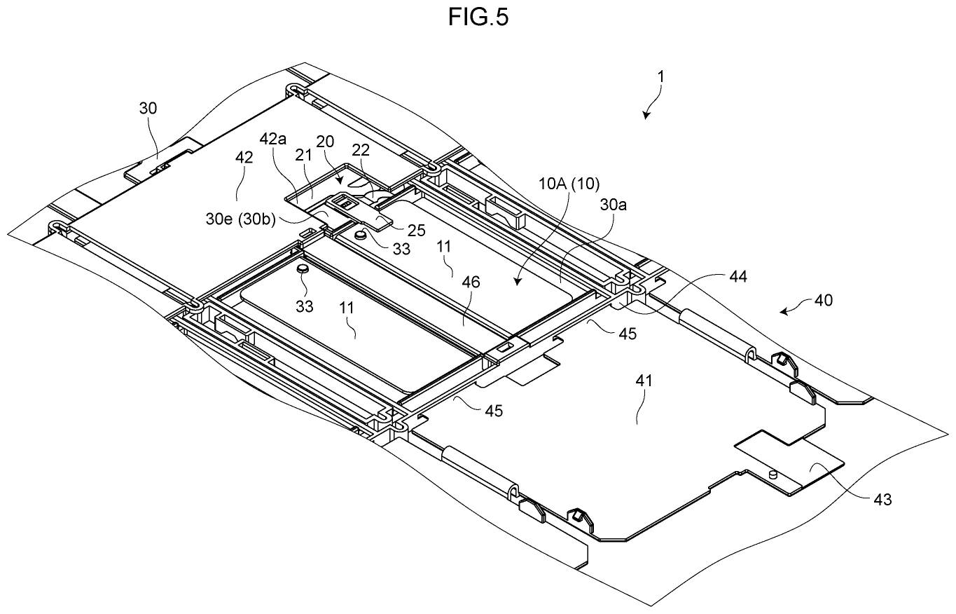

The bus bar 10 is provided with a terminal connection portion 11 that is physically and electrically connected to the electrode terminal BCb (FIGS. 4 and 5). The terminal connection portion 11 is physically and electrically connected to the electrode terminal BCb by laser welding.

As the bus bar 10, a bus bar that is physically and electrically connected to one electrode terminal BCb serving as a total negative electrode in the battery module BM, and a bus bar that is physically and electrically connected to one electrode terminal BCb serving as a total positive electrode in the battery module BM are provided.

In addition, as the bus bar 10, a bus bar (hereinafter, referred to as a “bus bar 10A”) that is physically and electrically connected to the electrode terminals BCb adjacent to each other in the arrangement direction of a pair of battery cells BC in the battery module BM is provided (FIGS. 4 and 5). The bus bar 10A includes the terminal connection portion 11 for each of the electrode terminals BCb, which is physically and electrically connected to two electrode terminals BCb adjacent to each other in the arrangement direction, and a gap adjustment portion 12 that is provided between the pair of terminal connection portions 11 and is capable of adjusting a gap between the pair of terminal connection portions 11 in the arrangement direction (FIG. 4).

The pair of terminal connection portions 11 illustrated here is formed in a rectangular flat plate shape on the same plane (FIGS. 4 and 5). The pair of terminal connection portions 11 is formed in the same rectangular shape.

The gap adjustment portion 12 can change the gap between the pair of terminal connection portions 11, for example, by bending itself in the arrangement direction. For example, when a gap (in other words, an inter-terminal pitch) in the arrangement direction between two electrode terminals BCb adjacent to each other in the arrangement direction changes due to thermal expansion or the like of the cell body BCa, the gap adjustment portion 12 changes the gap between the pair of terminal connection portions 11 following the change. Further, for example, when a gap between the pair of terminal connection portions 11 and an inter-terminal pitch deviate due to a tolerance variation of the bus bar 10A or the like, the gap adjustment portion 12 can also absorb the deviation by changing the gap between the pair of terminal connection portions 11 in accordance with the deviation amount.

The gap adjustment portion 12 illustrated here is formed in a recessed shape having a first wall portion 12a extending upward from a side portion of one of the terminal connection portions 11, a second wall portion 12b extending upward from a side portion of the other terminal connection portion 11, and a rectangular flat plate-shaped third wall portion 12c that is a wall portion that connects the first wall portion 12a to the second wall portion 12b and is parallel to a plane of the pair of terminal connection portions 11 (FIG. 4).

The wiring component 20 is a component provided to electrically connect the battery module BM to the battery monitoring unit.

The wiring component 20 is provided with a plurality of conductor portions (not illustrated) for electrically connecting the battery module BM to the battery monitoring unit. The wiring component 20 includes, as the conductor portion, for example, a conductor portion (hereinafter, referred to as a “voltage detection conductor portion”) for each bus bar 10 that electrically connects the bus bar 10 to the battery monitoring unit and causes the battery monitoring unit to monitor a voltage of the battery cell BC to which the bus bar 10 is connected.

The wiring component 20 illustrated here is a flexible wiring component that is formed flat with flexibility, and includes a plurality of conductor portions and an insulating coating that encloses the plurality of conductor portions. The wiring component 20 in this example is a flexible printed circuit (FPC) board including patterns (so-called conductor patterns) of a plurality of circuit conductors to be conductor portions. The wiring component 20 includes, as the insulating coating, various films (base film and cover film) formed flat with flexibility, and a conductor pattern is formed on at least one (base film) of the various films. The conductor pattern is enclosed by the insulating coating, and for example, a location to be an electrical contact point with another component is exposed.

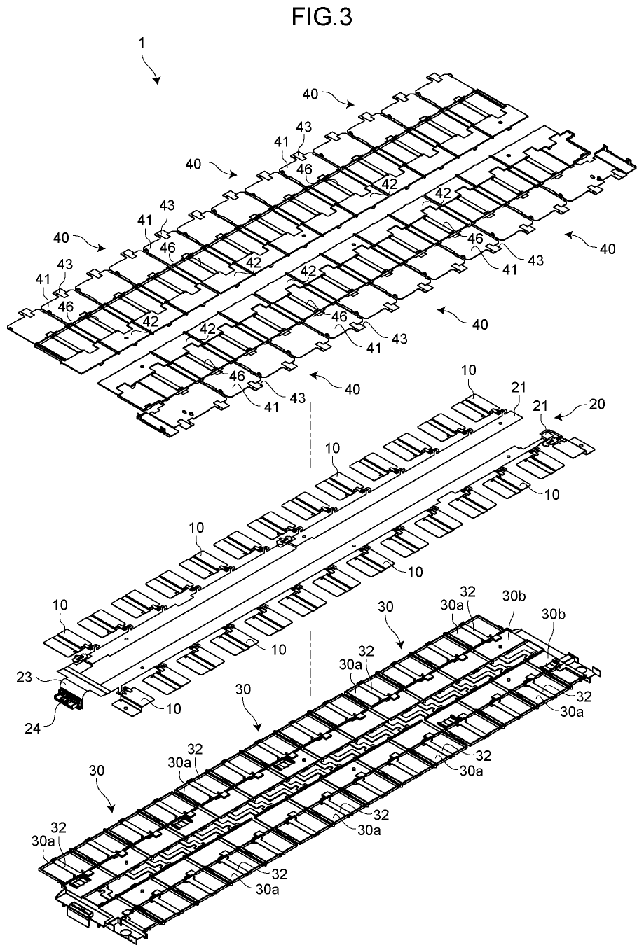

The wiring component 20 includes a wiring main body 21 extending in the arrangement direction and a branch body (hereinafter, referred to as a “voltage detection branch body”) 22 branching from the wiring main body 21 toward the bus bar 10 (FIGS. 3 and 5). In the wiring component 20, the voltage detection conductor portion is routed between the wiring main body 21 and the voltage detection branch body 22.

The wiring main body 21 illustrated here is formed in a rectangular flat plate shape and is disposed between the two electrode terminal groups BCc and BCd in the battery module BM. The wiring component 20 illustrated here has the wiring main body 21 for each of the electrode terminal groups BCc and BCd, and the ends of the two wiring main bodies 21 are connected to each other by a coupling body 23 (FIGS. 1 to 3). A connector 24 to be fitted and connected to a connector on the battery monitoring unit side is connected to the coupling body 23 (FIGS. 1 to 3). The connector 24 includes a terminal fitting (not illustrated) for each voltage detection conductor portion that is physically and electrically connected to one end of the voltage detection conductor portion of the coupling body 23.

The voltage detection branch body 22 is provided for each bus bar 10. An intermediate connection member 25 such as a metal conductive member is interposed between the voltage detection branch body 22 and the bus bar 10 (FIG. 5). The intermediate connection member 25 is physically and electrically connected to the voltage detection conductor portion of the voltage detection branch body 22 and the bus bar 10 by, for example, laser welding or the like, and electrically connects the voltage detection conductor portion to the bus bar 10.

The housing member 30 is formed of an insulating material such as synthetic resin, and is placed and installed on the battery module BM. In the conductive module 1 illustrated here, the plurality of housing members 30 are arranged in the arrangement direction.

The housing member 30 is provided with a bus bar housing chamber 30a that houses the bus bar 10 at a housing completion position (FIGS. 3 to 5). The housing member 30 is provided with a wiring housing chamber 30b that houses the wiring component 20 (FIGS. 3 to 5).

The bus bar housing chamber 30a is formed for each bus bar 10. In the housing member 30, the plurality of bus bar housing chambers 30a are arranged in the arrangement direction for the respective electrode terminal groups BCc and BCd, and an assembly of the plurality of bus bar housing chambers 30a is formed for each of the electrode terminal groups BCc and BCd.

In the housing member 30, a rectangular frame portion 31 is provided for each bus bar 10, and an internal space of the frame portion 31 is used as the bus bar housing chamber 30a (FIG. 4). In the bus bar housing chamber 30a, the terminal connection portion 11 of the bus bar 10 at the housing completion position and the electrode terminal BCb are brought into surface contact with each other using an opening on the battery cell BC side in the frame portion 31. In the bus bar housing chamber 30a, an opening in the frame portion 31, that is located on the side opposite to the battery cell BC side, is used as a bus bar insertion port 30c (FIG. 4). The bus bar 10 is inserted into the bus bar housing chamber 30a from the bus bar insertion port 30c.

The bus bar housing chamber 30a is provided with a bus bar placement portion 32 on which the bus bar 10 at the housing completion position is placed at a location avoiding a connection position between the terminal connection portion 11 of the bus bar 10 and the electrode terminal BCb and on the battery cell BC side relative to the bus bar insertion port 30c (FIGS. 3 and 4). For example, in the bus bar housing chamber 30a that houses the bus bar 10A, the bus bar placement portion 32 is formed in such a way that the opening in the frame portion 31 on the battery cell BC side is divided into two in the arrangement direction. The third wall portion 12c of the gap adjustment portion 12 of the bus bar 10A is placed on the bus bar placement portion 32. Therefore, the bus bar placement portion 32 is formed in a rectangular flat plate shape so as to match the shape of the third wall portion 12c and to bring the third wall portion 12c into surface contact.

Here, the third wall portion 12c is placed on the bus bar placement portion 32 outside the recess in the gap adjustment portion 12. However, the third wall portion 12c may be placed on the bus bar placement portion 32 in a state in which the bus bar placement portion 32 is inserted into the recess in the gap adjustment portion 12.

The bus bar housing chamber 30a is provided with a plurality of positioning pins 33 protruding from the battery cell BC side toward the bus bar insertion port 30c at locations avoiding connection positions between the terminal connection portion 11 of the bus bar 10 and the electrode terminal BCb (FIGS. 4 and 5). The plurality of positioning pins 33 are protruding portions for positioning the bus bar 10 of the bus bar housing chamber 30a at the housing completion position, and restrict movement of the terminal connection portion 11 in the bus bar 10 in a surface direction. Therefore, in the bus bar 10, positioning holes 13 into which the positioning pins 33 are inserted at the housing completion position are provided for the respective positioning pins 33 (FIG. 4). For example, in the bus bar 10A, one positioning hole 13 is provided in each terminal connection portion 11. Here, two positioning holes 13 are formed in the terminal connection portions 11 so as to sandwich the gap adjustment portion 12. The positioning pins 33 are arranged in accordance with the positions of the positioning holes 13. Here, the positioning pin 33 protrudes with the same flat surface portion as the contact surface of the bus bar placement portion 32 with the bus bar 10 as a root.

The wiring housing chamber 30b is provided for each wiring main body 21 (in other words, for each of the electrode terminal groups BCc and BCd). Two wiring housing chambers 30b are arranged between the assemblies of the bus bar housing chambers 30a for each of the electrode terminal groups BCc and BCd. The wiring housing chamber 30b is provided adjacent to the assembly of the bus bar housing chambers 30a. In the wiring housing chamber 30b, the wiring main body 21 and the voltage detection branch body 22 inserted from a wiring insertion port 30d are placed on a bottom portion 30e (FIGS. 4 and 5).

The cover member 40 is formed of an insulating material such as synthetic resin. The cover member 40 illustrated here is provided for each housing member 30. Furthermore, the cover member 40 illustrated here is provided for each of the electrode terminal groups BCc and BCd.

The cover member 40 is provided with a bus bar cover portion 41 that closes the bus bar insertion port 30c of the housing member 30 and covers the bus bar 10 (FIGS. 1 to 5). The cover member 40 is provided with a wiring cover portion 42 that covers the wiring insertion port 30d of the housing member 30 and covers the wiring main body 21 (FIGS. 1 to 5). The cover member 40 is provided with a branch line cover portion 43 that covers the wiring insertion port 30d of the housing member 30 and covers the voltage detection branch body 22 and the intermediate connection member 25 (FIGS. 1 to 5).

The bus bar cover portion 41 is formed for each bus bar housing chamber 30a of the housing member 30. The bus bar cover portion 41 is formed in a rectangular shape corresponding to the rectangular bus bar insertion port 30c.

Here, the cover member 40 is provided with a frame portion 44 overlapping the frame portion 31 of the housing member 30 for each frame portion 31 (FIGS. 4 and 5). In the cover member 40, the bus bar cover portion 41 for each bus bar housing chamber 30a of the housing member 30 is connected to the frame portion 44 in an openable-and-closable manner via a living hinge 45 (FIGS. 4 and 5). The living hinge 45 opens and closes the bus bar cover portion 41 with respect to the frame portion 44 between an open position at which the bus bar insertion port 30c is opened and a closed position at which the bus bar insertion port 30c is closed.

In the cover member 40, the branch line cover portion 43 is formed as one cover portion integrated with the bus bar cover portion 41. Therefore, the branch line cover portion 43 is opened and closed with respect to the frame portion 44 via the living hinge 45 together with the bus bar cover portion 41. The branch line cover portion 43 protrudes from the bus bar cover portion 41 on the same plane, exposes the voltage detection branch body 22 and the intermediate connection member 25 at the open position with respect to the frame portion 44, and covers the voltage detection branch body 22 and the intermediate connection member 25 at the closed position with respect to the frame portion 44.

The wiring cover portion 42 may cover the entirety of the wiring insertion port 30d of the housing member 30 over the arrangement direction, or may divide the wiring insertion port 30d of the housing member 30 into a plurality of sections in the arrangement direction and may cover each section. For example, the wiring cover portion 42 is provided for each bus bar housing chamber 30a so as to be provided adjacent to the bus bar housing chamber 30a of the housing member 30. The wiring cover portion 42 illustrated here has a rectangular flat plate shape as a main body, and a notch 42a for fitting the branch line cover portion 43 at the closed position is formed in the main body (FIGS. 4 and 5). Each wiring cover portion 42 is connected to the frame portion 44.

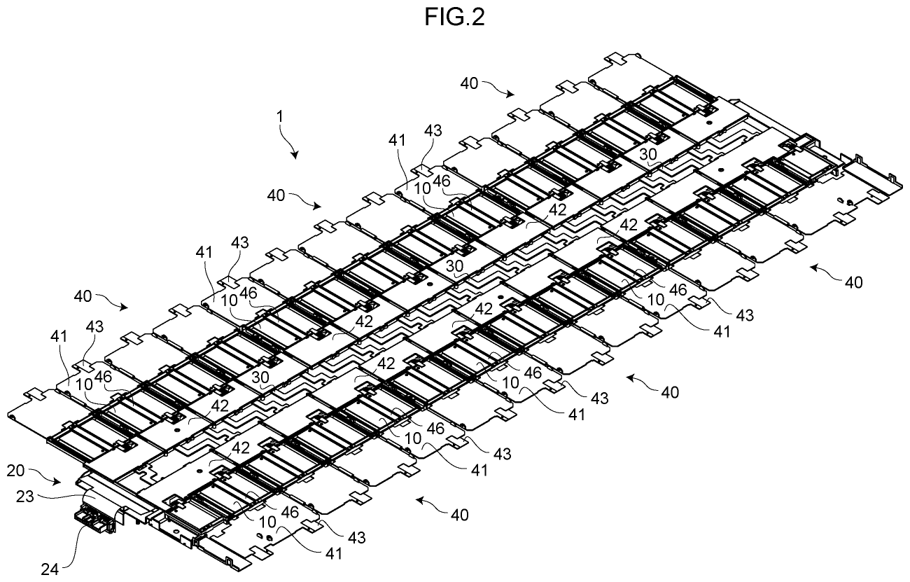

The cover member 40 is further provided with a bus bar pressing portion 46 that is placed on the bus bar 10 at the housing completion position and sandwiches the bus bar 10 between the bus bar pressing portion 46 and the bus bar placement portion 32 of the housing member 30 (FIGS. 2 to 5). The third wall portion 12 c of the gap adjustment portion 12 of the bus bar 10 is sandwiched between the bus bar placement portion 32 and the bus bar pressing portion 46. Here, since the third wall portion 12c is placed on the bus bar placement portion 32 outside the recess of the gap adjustment portion 12, the third wall portion 12c is sandwiched between the bus bar placement portion 32 and the bus bar pressing portion 46 in a state in which the bus bar pressing portion 46 is inserted into the recess of the gap adjustment portion 12. However, when the third wall portion 12c is placed on the bus bar placement portion 32 in a state in which the bus bar placement portion 32 is inserted into the recess of the gap adjustment portion 12, the bus bar pressing portion 46 is placed on the third wall portion 12c outside the recess of the gap adjustment portion 12.

The bus bar pressing portion 46 illustrated here is formed in a rectangular flat plate shape extending between the wiring cover portion 42 and the frame portion 44 on the living hinge 45 side. Then, the bus bar pressing portion 46 illustrated here is placed on the third wall portion 12c of the gap adjustment portion 12 in the bus bar 10 by assembling the cover member 40 with the housing member 30. Therefore, the bus bar cover portion 41 covers the bus bar pressing portion 46 together with the bus bar 10 at the closed position (FIGS. 1 to 5).

As described above, in the conductive module 1 according to the present embodiment, by inserting the plurality of positioning pins 33 of the bus bar housing chamber 30a in the housing member 30 into the positioning holes 13 in the bus bar 10 at the housing completion position, it is possible to suppress the positional deviation of the bus bar 10 in a direction along a plane orthogonal to a protruding direction of the positioning pins 33. Further, in the conductive module 1 according to the present embodiment, the bus bar 10 at the housing completion position is placed on the bus bar placement portion 32 of the bus bar housing chamber 30a in the housing member 30, and the bus bar 10 is sandwiched between the bus bar placement portion 32 and the bus bar pressing portion 46 of the cover member 40, thereby making it possible to suppress the positional deviation of the bus bar 10 toward the bus bar insertion port 30c side. In the conductive module 1 according to the present embodiment, the bus bar 10 can be stopped at the housing completion position by these bus bar holding structures (the positioning hole 13, the positioning pin 33, the bus bar placement portion 32, and the bus bar pressing portion 46). Therefore, as compared with a conductive module of the related art, the conductive module 1 according to the present embodiment does not require a locking claw for holding the bus bar unlike the conductive module of the related art, and thus the housing member 30 to a side opposite to the battery cell BC side when viewed from the bus bar 10 (in other words, in the protruding direction of the positioning pin 33) does not need to be enlarged. Therefore, the conductive module 1 according to the present embodiment can suppress, as compared with the conductive module of the related art, an increase in size of the housing member 30 on the side opposite to the battery cell BC side. As described above, the conductive module 1 according to the present embodiment is provided with the bus bar holding structures (the positioning hole 13, the positioning pin 33, the bus bar placement portion 32, and the bus bar pressing portion 46) capable of reducing height. Accordingly, it is possible to contribute to reducing the height of the battery pack BP. In addition, since the height of the conductive module 1 according to the present embodiment is reduced, the size of each battery cell BC can be increased by the reduced size, so that a capacity (that is, a battery capacity) of the battery module BM can be increased, a cruising range can be extended, and output of a rotary machine can be increased.

Further, in the conductive module 1 according to the present embodiment, in the bus bar 10A, the positioning holes 13 are provided one by one in the terminal connection portions 11 so as to sandwich the gap adjustment portions 12 in the arrangement direction. Therefore, even if the positions of the positioning holes 13 and the positioning pins 33 deviate due to a tolerance variation or the like, the positioning pins 33 can be inserted into the positioning holes 13 by bending the gap adjustment portions 12 in the arrangement direction.

In a conductive module according to the present embodiment, by inserting a plurality of positioning pins of a bus bar housing chamber in a housing member into a positioning hole in a bus bar at a housing completion position, it is possible to suppress positional deviation of the bus bar in a direction along a plane orthogonal to a protruding direction of the positioning pin. Further, in the conductive module according to the present embodiment, the bus bar at the housing completion position is placed on a bus bar placement portion of the bus bar housing chamber in the housing member, and the bus bar is sandwiched between the bus bar placement portion and a bus bar pressing portion of a cover member, so that it is possible to suppress positional deviation of the bus bar toward a bus bar insertion port side. In the conductive module according to the present embodiment, the bus bar can be stopped at the housing completion position by these bus bar holding structures (the positioning hole, the positioning pin, the bus bar placement portion, and the bus bar pressing portion). Therefore, as compared with a conductive module of the related art, the conductive module according to the present invention does not require a locking claw for holding the bus bar unlike the conductive module of the related art, and thus the housing member to a side opposite to a battery cell side when viewed from the bus bar (in other words, in the protruding direction of the positioning pin) does not need to be enlarged. Therefore, the conductive module according to the present embodiment can suppress, as compared with the conductive module of the related art, an increase in size of the housing member on the side opposite to the battery cell side. As described above, the conductive module according to the present invention is provided with the bus bar holding structures (the positioning hole, the positioning pin, the bus bar placement portion, and the bus bar pressing portion) capable of reducing height. Accordingly, it is possible to contribute to reducing the height of a battery pack. In addition, since the height of the conductive module according to the present invention is reduced, the size of each battery cell can be increased by the reduced size, so that a capacity (that is, a battery capacity) of the battery module can be increased, a cruising range can be extended, and output of a rotary machine can be increased.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar physically and electrically connected to an electrode terminal of one or a pair of battery cells in a battery module having a plurality of the battery cells arranged therein in a row;
a housing member provided with a bus bar housing chamber configured to house the bus bar inserted from a bus bar insertion port at a housing completion position; and
a cover member provided with a bus bar cover portion configured to close the bus bar insertion port and to cover the bus bar, wherein
the bus bar housing chamber is provided with a bus bar placement portion and a plurality of positioning pins, the bus bar placement portion being configured for the bus bar at the housing completion position to be placed at a location avoiding a connection position between the bus bar and the electrode terminal and on the battery cell side relative to the bus bar insertion port, the positioning pins protruding from the battery cell side toward the bus bar insertion port at the location avoiding the connection position,
the bus bar has a positioning hole formed therein and provided for each of the positioning pins, the positioning hole being configured for the positioning pin to be inserted thereinto at the housing completion position, and
the cover member is provided with a bus bar pressing portion placed on the bus bar at the housing completion position, the bus bar pressing portion and the bus bar placement portion sandwiching the bus bar therebetween.

2. The conductive module according to claim 1, wherein
the bus bar includes a terminal connection portion for each of the electrode terminals, the terminal connection portion being physically and electrically connected to two of the electrode terminals adjacent to each other in an arrangement direction of the plurality of battery cells, and a gap adjustment portion provided between a pair of the terminal connection portions, the gap adjustment portion being capable of adjusting a gap between the pair of terminal connection portions in the arrangement direction, and
one positioning hole is provided in each of the terminal connection portions.

3. The conductive module according to claim 2, wherein
the pair of terminal connection portions is formed in a rectangular flat plate shape on the same plane,
the gap adjustment portion is formed in a recessed shape having a first wall portion extending upward from a side portion of one of the terminal connection portions, a second wall portion extending upward from a side portion of the other terminal connection portion, and a rectangular flat plate-shaped third wall portion serving as a wall portion connecting the first wall portion to the second wall portion, the third wall portion being parallel to a plane of the pair of terminal connection portions, and
the third wall portion is sandwiched between the bus bar placement portion and the bus bar pressing portion.

4. The conductive module according to claim 1, wherein
the bus bar pressing portion is placed on the bus bar by assembling the cover member with the housing member, and
the bus bar cover portion covers the bus bar pressing portion together with the bus bar.

5. The conductive module according to claim 2, wherein
the bus bar pressing portion is placed on the bus bar by assembling the cover member with the housing member, and
the bus bar cover portion covers the bus bar pressing portion together with the bus bar.

6. The conductive module according to claim 3, wherein
the bus bar pressing portion is placed on the bus bar by assembling the cover member with the housing member, and
the bus bar cover portion covers the bus bar pressing portion together with the bus bar.
